(19) United States
(12) Patent Application Publication
(10) Pub. No.: US 2016/0222261 A1
(43) Pub. Date: Aug. 4, 2016

(54) ADHESIVE COMPOSITION FOR MEDICAL DEVICES AND MEDICAL DEVICE

(71) Applicant: OLYMPUS CORPORATION, Tokyo (JP)

(72) Inventors: Hiroki YOKOYAMA, Tokyo (JP); Koji KOBAYASHI, Tokyo (JP); Jun MATSUMOTO, Tokyo (JP); Rieko NIINO, Tokyo (JP)

(73) Assignee: OLYMPUS CORPORATION, Tokyo (JP)

(21) Appl. No.: 15/097,136

(22) Filed: Apr. 12, 2016

Related U.S. Application Data
(63) Continuation of application No. PCT/JP2014/076275, filed on Oct. 1, 2014.

(30) Foreign Application Priority Data
Dec. 17, 2013 (JP) 2013-260599

(51) Int. Cl. C09J 163/00; B32B 7/12

(52) U.S. Cl. CPC C09J 163/00; B32B 7/12; B32B 2535/00; B32B 2255/26

(57) ABSTRACT

An adhesive composition for medical devices of the present invention includes at least one epoxy resin (A) selected from the group consisting of a bisphenol A epoxy resin, a bisphenol F epoxy resin, and a phenol novolak epoxy resin, and modified silicone (B), wherein the epoxy resin (A) is mixed with the modified silicone B.

This application is a continuation application, based on PCT/JP2014/076275, filed on Oct. 1, 2014, claiming priority based on Japanese Patent Application No. 2013-260599, filed in Japan on Dec. 17, 2013, the content of which is incorporated herein by reference.

### BACKGROUND OF THE INVENTION

1. Field of the Invention

The present invention relates to an adhesive composition for medical devices, and a medical device.

2. Description of the Related Art

Medical devices before or after use may be sterilized with high-temperature, high-pressure vapor in an autoclave, or with chemicals such as peracetic acid or gases (hydrogen peroxide gas, ethylene oxide gas, and the like). An example of a medical device to be sterilized is an endoscope which is inserted into a human body cavity or the like.

A medical device such as an endoscope includes a portion in which multiple members are joined together with an adhesive.

When the medical device is repeatedly sterilized with an autoclave or chemicals, performance of the adhesive is degraded by water vapor or chemicals, and the members joined together with the adhesive may be separated from each other. Due to the sterilization treatment, the adhesive may be discolored, melted by chemicals or the like, or cracked such that the exterior of an adhesive layer exposed to a surface of the medical device is damaged. In a hydrogen peroxide plasma treatment, exposure of an adhesive to chemicals may cause problems in that an adhesive layer is separated from a member to which the adhesive layer is joined, or bubbles are formed in the surface of the adhesive layer.

In the related art, for example, a method of joining members together in an endoscope using an adhesive, which is obtained by mixing an amine-based curing agent with a main component in which rubber and/or plastic is added to an epoxy resin, is disclosed (refer to Japanese Unexamined Patent Application, First Publication No. 2003-126023, and Japanese Unexamined Patent Application, First Publication No. 2002-238834).

A joining method using an adhesive, which contains a main component containing a bisphenol A epoxy resin, a phenol novolak epoxy resin, and acrylic rubber; a curing agent containing xylylenediamine and the like; and a specific silica as a filler, is disclosed (refer to PCT International Publication No. WO 2011/126018).

### SUMMARY OF THE INVENTION

### Means for Solving the Problem

The present invention adopts the following means to solve the aforementioned problem, and to achieve the object.

In an adhesive composition for medical devices according to a first aspect of the present invention, at least one epoxy resin (A) selected from the group consisting of a bisphenol A epoxy resin, a bisphenol F epoxy resin, and a phenol novolak epoxy resin is mixed with modified silicone (B).

According to a second aspect of the present invention, in the adhesive composition for medical devices of the first aspect, the modified silicone (B) may be at least one selected from the group consisting of epoxy-modified silicone and amine-modified silicone

According to a third aspect of the present invention, in the adhesive composition for medical devices of the second aspect, the epoxy-modified silicone and the amine-modified silicone may be used together as the modified silicone (B), and the mass ratio of the epoxy-modified silicone to the amine-modified silicone is in a range of 0.2 to 3.

According to a fourth aspect of the present invention, in the adhesive composition for medical devices of the first aspect, the mass average molecular weight of the modified silicone (B) may be in a range of 100 to 10000.

According to a fifth aspect of the present invention, in the adhesive composition for medical devices of the first aspect, the content of the modified silicone (B) may be in a range of 10 parts by mass to 75 parts by mass with respect to 100 parts by mass of the epoxy resin (A).

In a medical device according to a sixth aspect of the present invention, members are joined together with the adhesive composition for medical devices according to the first aspect.

According to a seventh aspect of the present invention, the medical device of the sixth aspect may include an insertion portion, an operation portion connected to the insertion portion, and a universal cord which is electrically connected to the operation portion.

A manufacturing method for an adhesive composition for medical devices according to a eighth aspect includes a step of mixing at least one epoxy resin (A) selected from the group consisting of bisphenol A epoxy resin, bisphenol F epoxy resin, and phenol novolak epoxy resin with modified silicone (B).

According to a ninth aspect of the present invention, in the manufacturing method for an adhesive composition for medical devices of the eighth aspect, the modified silicone (B) may be at least one selected from the group consisting of epoxy-modified silicone and amine-modified silicone.

According to a tenth aspect of the present invention, in the manufacturing method for an adhesive composition for medical devices of the ninth aspect, the epoxy-modified silicone and the amine-modified silicone are used together as the modified silicone (B), and the mass ratio of the epoxy-modified silicone to the amine-modified silicone may be in a range of 0.2 to 3.

According to a eleventh aspect of the present invention, in the manufacturing method for an adhesive composition for medical devices of the eighth aspect, the mass average molecular weight of the modified silicone (B) may be in a range of 100 to 10000.

According to a twelfth aspect of the present invention, in the manufacturing method for an adhesive composition for medical devices of the eighth aspect, the content of the modified silicone (B) may be in a range of 10 parts by mass to 75 parts by mass with respect to 100 parts by mass of the epoxy resin (A).

### BRIEF DESCRIPTION OF THE DRAWINGS

FIG. 1 is a perspective view illustrating an example of the schematic configuration of an endoscope in which members are joined together using an adhesive composition for medical devices in the present invention.

FIG. 2 is a front view of a tip end portion of the endoscope illustrated in FIG. 1.

FIG. 3 is a sectional view of the tip end portion taken along line A-A in FIG. 2.

### DETAILED DESCRIPTION OF THE INVENTION

<Adhesive Composition for Medical Devices>

An adhesive composition for medical devices (hereinafter, may be simply referred to as an “adhesive composition”) in the present invention contains at least one epoxy resin (A) (hereinafter, may be referred to as an “(A) component”) selected from the group consisting of a bisphenol A epoxy resin, a bisphenol F epoxy resin, and a phenol novolak epoxy resin; and modified silicone (B) (hereinafter, may be referred to as a “(B) component”).

A two-pack adhesive composition is preferably used as the adhesive composition of the present invention. Heating causes a progress in the chemical reaction of the two-pack adhesive composition to progress such that curing of the two-pack adhesive composition is promoted. An example of such an adhesive composition is a two-pack adhesive composition that contains a main component containing the (A) component, and a curing agent. A main component or a curing agent may contain the (B) component according to the type of the (B) component. A main component and a curing agent may respectively contain two or more (B) components.

### (Epoxy Resin (A))

At least one epoxy resin, which is selected from the group consisting of a bisphenol A epoxy resin, a bisphenol F epoxy resin, and a phenol novolak epoxy resin, is used as the (A) component of the present invention.

Above all, at least one selected from the group consisting of a bisphenol A epoxy resin and a bisphenol F epoxy resin is preferably contained as the (A) component in that, when a sterilization treatment is repeatedly performed, sterilization resistance is further improved, and proper viscosity or high adhesive strength is easily obtained.

Above all, a combination of a bisphenol A epoxy resin and a bisphenol F epoxy resin, a combination of a bisphenol A epoxy resin and a phenol novolak epoxy resin, a combination of a bisphenol F epoxy resin and a phenol novolak epoxy resin, or a combination of a bisphenol A epoxy resin, a bisphenol F epoxy resin, and a phenol novolak epoxy resin is more preferably used as the (A) component. A combination of a bisphenol A epoxy resin, a bisphenol F epoxy resin, and a phenol novolak epoxy resin is particularly preferable.

For example, jER (registered trademark) 828 (manufactured by Mitsubishi Chemical Corporation) or the like can be used as the bisphenol A epoxy resin.

When the total mass of the (A) component is 100% by mass, the content of the bisphenol A epoxy resin in the adhesive composition is preferably set to be 40% by mass or greater, more preferably in a range of 40% by mass to 100% by mass, still more preferably 40% by mass to 95% by mass, particularly preferably 40% by mass to 90% by mass, and most preferably 40% by mass to 80% by mass.

When the content of the bisphenol A epoxy resin is the preferable low-limit value or greater, particularly, the adhesive strength to a sterilization treatment using chemicals is easily maintained.

For example, jER (registered trademark) 807 (manufactured by Mitsubishi Chemical Corporation) or the like can be used as the bisphenol F epoxy resin.

When the total mass of the (A) component is 100% by mass, the content of the bisphenol F epoxy resin in the adhesive composition is preferably set to be 40% by mass or greater, more preferably in a range of 40% by mass to 100% by mass, still more preferably 40% by mass to 95% by mass, particularly preferably 40% by mass to 90% by mass, and most preferably 40% by mass to 80% by mass.

When the content of the bisphenol F epoxy resin is the preferable low-limit value or greater, particularly, the adhesive strength to a sterilization treatment using chemicals is easily maintained.

For example, N-770 (product name) (manufactured by DIC Corporation) or the like can be used as the phenol novolak epoxy resin.

When the total mass of the (A) component is 100% by mass, the content of the phenol novolak epoxy resin in the adhesive composition is preferably set to be 5% by mass or greater, more preferably in a range of 5% by mass to 20% by mass, and still more preferably 10% by mass to 20% by mass.

When the content of the phenol novolak epoxy resin is the preferable low-limit value or greater, the adhesive strength is further increased.

### (Modified Silicone (B))

The “modified silicone” of the present invention is polysiloxane in which an organic group (except for a methyl group) is introduced onto at least one of an end of a main chain and a side chain. Specifically, an organic group is introduced only onto a side chain of polysiloxane, one end of a main chain of polysiloxane, both ends of a main chain of polysiloxane, a side chain and one end of a main chain of polysiloxane, or a side chain and either of both ends of a main chain of polysiloxane. Examples of a well-known introduced organic group of modified silicone include an oxyalkylene group, an epoxy group, an amino group, a carboxy group, and an aralkyl group.

The (B) component is not limited to a specific component. Examples of the (B) component include epoxy-modified silicone, amine-modified silicone, carboxyl-modified silicone, and fluoro-modified silicone. Above all, epoxy-modified silicone and amine-modified silicone are preferably used as the (B) component.

Epoxy-modified silicone refers to polysiloxane in which an epoxy group as an organic group, or a substituent group containing an epoxy group is introduced. SF8413 (manufactured by Dow Corning Toray Co., Ltd.), BY16-839 (manufactured by Dow Corning Toray Co., Ltd.), or the like can be used as the epoxy-modified silicone.

Amine-modified silicone refers to polysiloxane in which an amine group as an organic group, or a substituent group containing an amine group is introduced. WACKER (registered trademark) WR301 (manufactured by Wacker Asahikasei Silicone Co., Ltd.), FZ-3785 (manufactured by Dow Corning Toray Co., Ltd.), or the like can be used as the amine-modified silicone.

The mass average molecular weight (Mw) (in terms of the conversion of polystyrene according to gel permeation chromatography (GPC)) of the (B) component is preferably set to be in a range of 100 to 10000, and more preferably 200 to 2000. When the Mw of the (B) component is in the preferable range, sterilization resistance is further increased. In addition, a formed adhesive layer is not excessively hard, and has proper elasticity.

One (B) component alone may be used, or two or more (B) components may be used together.

The (B) component preferably is at least one selected from the group consisting of epoxy-modified silicone and amine-modified silicone among the aforementioned modified silicones.

Epoxy-modified silicone together with the (A) component is more preferably used as a main component of the adhesive composition because good sterilization resistance is obtained. Amine-modified silicone is more preferably used as a curing agent of the adhesive composition.

Also, epoxy-modified silicone and amine-modified silicone are preferably used together because sterilization resistance is further increased. In a case where epoxy-modified silicone and amine-modified silicone are used together, a mixing ratio of epoxy-modified silicone to amine-modified silicone, which is shown as (epoxy-modified silicone)/(amine-modified silicone), is preferably set to be a mass ratio of 0.2 to 3, more preferably 0.25 to 2, and still more preferably 0.5 to 1.5.

The content of the (B) component with respect to 100 parts by mass of the (A) component in the adhesive composition is preferably set to be in a range of 10 parts by mass to 75 parts by mass, more preferably 15 parts by mass to 70 part by mass, and still more preferably 20 parts by mass to 65 parts by mass.

When the content of the (B) component is the preferable low-limit value or greater, sterilization resistance is further improved. In contrast, when the content of the (B) component is the preferable upper-limit value or less, a formed adhesive layer is unlikely to be hardened. Proper adhesive strength is easily obtained, and resistance to sterilization or disinfection, and cleaning is also increased. When the content of the (B) component exceeds the preferable upper-limit value, an improvement in the sterilization resistance is saturated.

### (Other Components)

The adhesive composition of the present invention may contain components other than the epoxy resin (A) and the modified silicone (B).

Examples of the other components include an epoxy resin other than the (A) component and the (B) component, a curing agent other than the (B) component, acrylic rubber, and a filler.

Epoxy Resin Other than (A) Component and (B) Component

Examples of the epoxy resin other than the (A) component and the (B) component include a brominated epoxy resin, an alicyclic epoxy resin, and a polyfunctional epoxy resin. A glycidyl-based reactive diluent may be used together as a main component of the adhesive composition.

Curing Agent Other than (B) Component

Examples of the curing agent other than the (B) component include metaxylylenediamine or a derivative thereof, a polyamide resin, imidazoles, and acid anhydrides.

Examples of the derivative of metaxylylenediamine include an alkylene oxide adduct, a glycidyl ester adduct, a glycidyl ether adduct, a Mannich adduct, an acrylonitrile adduct, an epichlorohydrin adduct, and a xylylene diamine trimer.

Above all, metaxylylenediamine or a derivative thereof is preferably used as a curing agent other than the (B) component because the speed of reaction with the (A) component is higher than the other. Above all, metaxylylenediamine is particularly preferably used as a curing agent other than the (B) component because metaxylylenediamine has an aromatic skeleton and a rigid structure.

In a case where metaxylylenediamine is used as a curing agent other than the (B) component, when the total mass of the curing agent is 100% by mass, the content of metaxylylenediamine in the adhesive composition is preferably set to be 10% by mass or greater, and more preferably in a range of 20% by mass to 100% by mass. When the content of metaxylylenediamine is in the preferable range, a proper reactive speed is obtained, and an effect such as the suppression of reaction with carbon dioxide in the air or an improvement in the adhesive strength is easily obtained.

In a case where a derivative of metaxylylenediamine is used as a curing agent other than the (B) component, when the total mass of the curing agent is 100% by mass, the content of the derivative of metaxylylenediamine in the adhesive composition is preferably set to be 10% by mass or greater, and more preferably in a range of 20% by mass to 70% by mass. When the content of the derivative of metaxylylenediamine is in the preferable range, a proper reactive speed is obtained, and an effect such as the suppression of reaction with carbon dioxide in the air or an improvement in the adhesive strength is easily obtained.

Examples of the preferable composition of the adhesive composition of the present invention include a composition which contains a main component containing the (A) component, and a curing agent containing amine-modified silicone (the (B) component); a composition which contains a main component containing the (A) component, and a curing agent containing amine-modified silicone (the (B) component) and metaxylylenediamine and/or a derivative of metaxylylenediamine; a composition which contains a main component containing the (A) component and epoxy-modified silicone (the (B) component), and a curing agent containing metaxylylenediamine and/or a derivative of metaxylylenediamine; a composition which contains a main component containing epoxy-modified silicone (the (A) component and the (B) component), and a curing agent containing amine-modified silicone (the (B) component); and a composition which contains a main component containing epoxy-modified silicone (the (A) component and the (B) component), and a curing agent containing amine-modified silicone (the (B) component) and metaxylylenediamine and/or a derivative of metaxylylenediamine.

The mixing ratio between the main component and the curing agent of the adhesive composition is preferably set in such a way that an epoxy group such as an epoxy resin contained in the main component reacts with a functional group (an amino group or the like) of the curing agent reacting with an epoxy group in terms of equivalents. The molecular weight of a main component per functional group refers to an epoxy equivalent, and the molecular weight of a curing agent per functional group refers to an amine equivalent. The amine equivalent of a curing agent is also referred to as an active hydrogen equivalent.

A theoretical mixing ratio is calculated based on the epoxy equivalent and the amine equivalent, and the calculated mixing ratio is used as a guideline to determine a proper mixing ratio. An optimum mixing ratio between the main component and the curing agent is preferably set in the viewpoint of adhesive strength or the like. Specifically, the mixing ratio (mass ratio) of the main component to the curing agent is preferably set to be in a range of 10:1 to 10:9, and more preferably 10:1 to 10:7.

When the mixing ratio of the main component to the curing agent is in the preferable range, it is possible to suppress the occurrence of any one of the oxidative degradation, the hydrolysis, the thermal softening degradation, the hardening degradation and the brittle fracture of the adhesive, and a decrease in the adhesive strength, and it is possible to easily form an adhesive layer having much better sterilization resistance.

When the total mass of the main component and the curing agent is 100% by mass, the content of the (B) component in the adhesive composition is preferably set to be in a range of 5% by mass to 60% by mass, and more preferably 10% by mass to 45% by mass.

When the content of the (B) component is the preferable low-limit value or greater, sterilization resistance is further increased. In contrast, when the content of the (B) component is the preferable upper-limit value or less, proper adhesive strength is easily obtained, and resistance to sterilization or disinfection, and cleaning is also increased. When the content of the (B) component exceeds the preferable upper-limit value, an improvement in the sterilization resistance is saturated.

In a case where epoxy-modified silicone is used as the (B) component, when the total mass of the main component is 100% by mass, the content of the epoxy-modified silicone in the adhesive composition is preferably set to be 5% by mass or greater, more preferably in a range of 10% by mass to 40% by mass, and still more preferably 15% by mass to 35% by mass.

When the content of the epoxy-modified silicone is the preferable low-limit value or greater, sterilization resistance is further increased.

In a case where epoxy-modified silicone is used as the (B) component, when the total mass of the main component is 100% by mass, the content of the bisphenol A epoxy resin in the adhesive composition is preferably set to be in a range of 20% by mass to 90% by mass, and more preferably 25% by mass to 80% by mass.

In a case where epoxy-modified silicone is used as the (B) component, when the total mass of the main component is 100% by mass, the content of the bisphenol F epoxy resin in the adhesive composition is preferably set to be in a range of 20% by mass to 90% by mass, and more preferably 25% by mass to 80% by mass.

In a case where epoxy-modified silicone is used as the (B) component, when the total mass of the main component is 100% by mass, the content of the phenol novolak epoxy resin in the adhesive composition is preferably set to be in a range of 4% by mass to 30% by mass, and more preferably 4% by mass to 20% by mass.

Only amine-modified silicone, which is the (B) component, may be used as a curing agent of the adhesive composition.

In a case where amine-modified silicone is used as the (B) component, when the total mass of the curing agent is 100% by mass, the content of the amine-modified silicone in the adhesive composition is preferably set to be 20% by mass or greater, and more preferably in a range of 25% by mass to 100% by mass. When the content of the amine-modified silicone is the preferable low-limit value or greater, sterilization resistance is further increased.

### Acrylic Rubber

Acrylic rubber may be used in the adhesive composition of the present invention. The use of acrylic rubber increases the crosslink density in addition to increasing the adhesion shear strength and adhesion peel strength, and further improves the autoclave resistance or the chemical resistance of a cured product. As a result, it is possible to easily obtain an adhesive composition having satisfactory adhesive strength even if the adhesive composition is repeatedly sterilized with high-temperature, high-pressure vapor, or with chemicals.

Acrylic rubber refers to synthetic rubber containing acrylic ester as a main component (50% by mass or greater). AC-3365 (manufactured by Aica Kogyo Co., Ltd.) or the like can be used as the acrylic rubber.

One acrylic rubber alone may be used, or two or more acrylic rubbers may be used together.

When acrylic rubber is used, the content of the acrylic rubber with respect to 100 parts by mass of the main component in the adhesive composition is preferably set to be in a range of 1 part by mass to 30 parts by mass, and more preferably 3 parts by mass to 25 parts by mass.

### Filler

Silica can be used as a filler of the adhesive composition.

For example, spherical silica having a particle diameter of 4 μm to 7 μm may be used. A user can observe and determine the shape of silica using an electron microscope. Fused silica such as spherical fused silica obtained by fusing natural quartz crystals in a burner, is an example of the silica used, and HPS-3500 (manufactured by Toagosei Corporation) or the like can be used as the silica. The mean particle diameter of the silica refers to a volume-based mean particle diameter, and can be obtained by a well-known method.

Only one silica may be used, or two or more silicas may be used together.

In case where silica is used, the content of the silica with respect to 100 parts by mass of the main component in the adhesive composition is preferably set to be in a range of 10 parts by mass to 40 parts by mass, and more preferably 20 parts by mass to 30 parts by mass.

When the total mass of the adhesive composition is 100% by mass, approximately 0.1% by mass to approximately 5% by mass of fumed silica may be mixed in the adhesive composition so as to take workability into consideration, and to increase the thixotropy of the adhesive composition.

The following additives other than the aforementioned components may be used in the adhesive composition: a catalyst, an adhesion imparting agent, a solvent, a plasticizer, an antioxidant, a polymerization inhibitor, a surfactant, an antifungal agent, a colorant, and the like. These additives may be added to the main component in advance. Alternatively, these additives may be added to a mixture of the main component and the curing agent.

### (Effects)

The adhesive composition of the present invention contains at least one epoxy resin (A) selected from the group consisting of a bisphenol A epoxy resin, a bisphenol F epoxy resin, and a phenol novolak epoxy resin; the modified silicone (B); and other components as necessary. Accordingly, a cured product formed by heating the adhesive composition is the reaction product of the (A) component and the (B) component, or the reaction product of the (A) component, the (B) component, and the curing agent.

That is, a silicone skeleton is formed in the structure of the cured product formed by heating the adhesive composition. The “silicone skeleton” refers to a structure formed by the repetition of —Si—O—.

The silicone skeleton is a portion of the structure of the (B) component. In the present invention, the silicone skeleton is easily introduced to the cured product by adopting the modified silicone (B) having high reactivity among silicones.

Multiple members in a medical device such as an endoscope are joined together with an adhesive layer. In the related art, when this medical device is sterilized with an autoclave or chemicals, main chains (polymerized portions) of a resin forming the adhesive layer are cut off, thereby causing degradation in the adhesive layer. Volatile low-molecular components obtained by the cutting off of the polymerized portions are vaporized in the bulk adhesive, and very small bubbles are formed in the surface of the adhesive layer, thereby causing the exterior to be damaged.

In contrast, an adhesive layer, which is formed by the adhesive composition for medical devices in the present invention, is composed of a cured product containing the silicone skeleton.

Since a strong bond is formed in the cured product due to high bonding energy of the silicone skeleton, the cutting off of the polymerized portions of the resin is suppressed during sterilization. Accordingly, even if being repeatedly sterilized, the adhesive composition for medical devices in the present invention has good sterilization resistance, and an adhesive layer in a medical device is capable of maintaining good adhesive strength.

Since the silicone skeleton has a structure having a high porosity, even if small bubbles are formed, the small bubbles in the adhesive layer are easily bled off. As a result, bubbles are unlikely to remain in the surface of the adhesive layer. Accordingly, even if the adhesive composition for medical devices in the present invention is repeatedly sterilized, the adhesive layer in the medical device is capable of maintaining a good exterior appearance. For this reason, the adhesive composition for medical devices in the present invention is useful particularly for a gaseous sterilization treatment such as a hydrogen peroxide plasma treatment.

An adhesive layer is exposed in a tip end portion of an endoscope. For this reason, the adhesive layer in the tip end portion of the endoscope is a portion which is relatively easily degraded by sterilization.

Due to a compressed state and a decompressed state in a sterilization treatment, members in the tip end portion of the endoscope are expanded and contracted. In a case where the adhesive layer, with which the members are joined together, has low elasticity or low hardness, the adhesive layer has good conformability to deformation (expansion, contraction, and the like) of the tip end portion. As a result, the adhesive layer in the tip end portion of the endoscope is unlikely to be degraded, and the adhesive strength is maintained.

Since an adhesive layer formed by the adhesive composition for medical devices in the present invention contains the modified silicone (B), the adhesive layer is not excessively hard, and has proper low elasticity. For example, an adhesive layer not containing the (B) component is assumed to have a durometer hardness of approximately D80, and in contrast, the adhesive composition of the present invention easily forms an adhesive layer having a durometer hardness of approximately D30 or greater and approximately D50 or less (the durometer hardness of the adhesive layer is measured by a well-known method).

As described above, an adhesive layer formed by the adhesive composition of the present invention has low elasticity and low hardness compared to the related art. Since the adhesive layer can conform to deformation (expansion, contraction, and the like) of members of a joining portion caused by heat applied during a sterilization treatment, the adhesive layer is unlikely to be degraded, and maintains good adhesive strength. That is, in a case where the adhesive composition of the present invention is used, joined members are unlikely to be separated from each other.

The sterilization treatment repeated is a specific treatment for medical devices. An adhesive layer formed by the adhesive composition for medical devices in the present invention has considerably high durability against the repeated sterilization treatment. That is, the adhesive composition for medical devices in the present invention is suitable particularly for medical devices.

The viscosity of the adhesive composition of the present invention can be easily adjusted to a viscosity suitable for operations such as joining members together and outer surface finishing in a medical device, and a viscosity suitable for forming a non-defective adhesive layer. The adhesive composition of the present invention is excellent in workability.

### <Medical Device>

In a medical device of the present invention, members are joined together with the adhesive composition for medical devices in the present invention.

An example, in which members in an endoscope as a medical device are joined together with an adhesive composition containing epoxy-modified silicone and amine-modified silicone as the (B) component, will be described. Since an endoscope is frequently sterilized, the endoscope is a suitable target of the present invention among medical devices.

First, a predetermined percent of liquid containing amine-modified silicone and other curing agents is mixed with a liquid (liquid containing a main component) containing the (A) component and epoxy-modified silicone, and other components (acrylic rubber, a filler, and the like) are added to the mixture as necessary. Subsequently, the obtained mixture is applied to the surfaces of predetermined members of the endoscope using a brush or the like, and the members are pasted and fixed together. Thereafter, the members are heated at a predetermined temperature for a predetermined amount of time such that the members in the endoscope are rigidly joined together.

The acrylic rubber, the filler, and the like may be added to the main component in advance.

The acrylic rubber may be dispersed in the bisphenol resin or the phenol novolak epoxy resin.

The heating temperature is appropriately determined according to the type of the main component and the curing agent contained in the adhesive composition, the mixing ratio, or the like, and is preferably set to be in an approximate range of 60° C. and 135° C. When the heating temperature is in the preferable range, a curing reaction can progress at a practical speed. Members of the endoscope having low heat resistance are unlikely to be thermally degraded. The heating time is preferably set to be in an approximate range of 0.5 hours to 3 hours.

In addition to joining the aforementioned members together in the endoscope with the adhesive composition of the present invention, it is possible to seal an image sensor, to finish the outer surface of a flexible outer tube end portion, and to fix the flexible outer tube end portion of the endoscope with the adhesive composition according to the same aforementioned method. In addition, it is possible to smooth angled portions in an outer circumference of an observation lens or an illumination lens by forming a protruding adhesive layer in the vicinity of the observation lens or the illumination lens according to the same method. In addition, it is possible to fix mouth portions of various tubes, which are inserted into an insertion portion of the endoscope, to a tip end of the insertion portion or an operation portion with the adhesive composition of the present invention.

It is also possible to fix a lens group, which are disposed in a hard tip end portion of the insertion portion, to a lens frame or the hard tip end portion with the adhesive composition of the present invention. It is also possible to fix a fiber bundle, which are inserted into the insertion portion, to the lens frame or the hard tip end portion with the adhesive composition of the present invention. The adhesive composition of the present invention can be used to protect and fix a CCD or the like assembled into the hard tip end portion.

It is possible to ensure the insertion of a flexible outer tube by finishing the outer surface of the flexible outer tube end portion with the adhesive composition of the present invention. Specifically, the flexible outer tube end portion of the insertion portion of the endoscope is fixed to a member inside of the insertion portion by tightly binding the flexible outer tube end portion with a thread from the outside, and then, the adhesive composition is applied to the thread. Accordingly, it is possible to ensure the insertion of the flexible outer tube, and to prevent the thread from becoming loose at the same time.

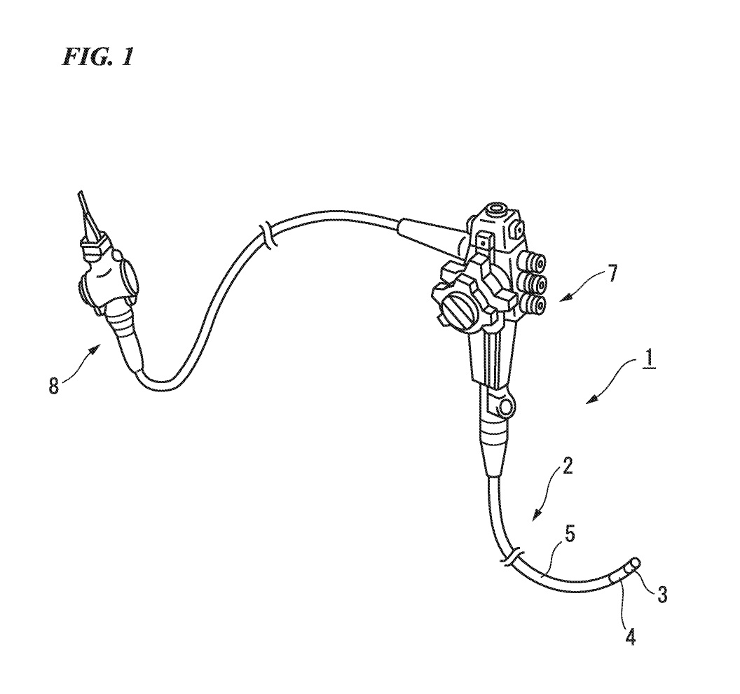

Hereinafter, an endoscope, in which members are joined together with the adhesive composition of the present invention, will be described in detail with reference to FIGS. 1 to 3.

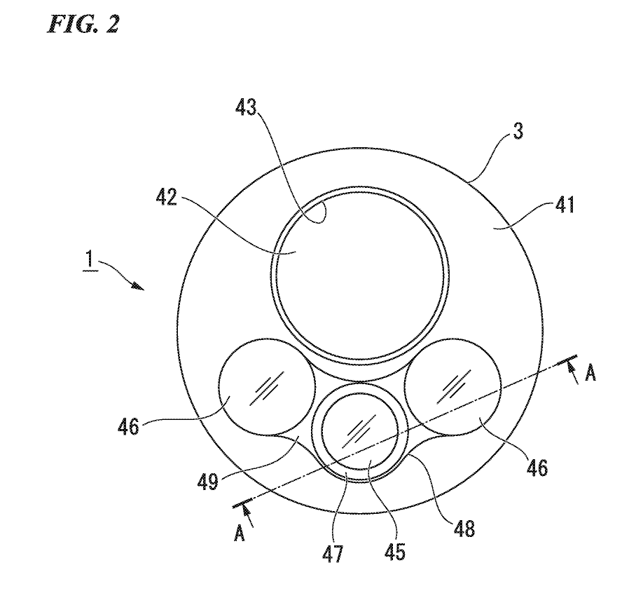

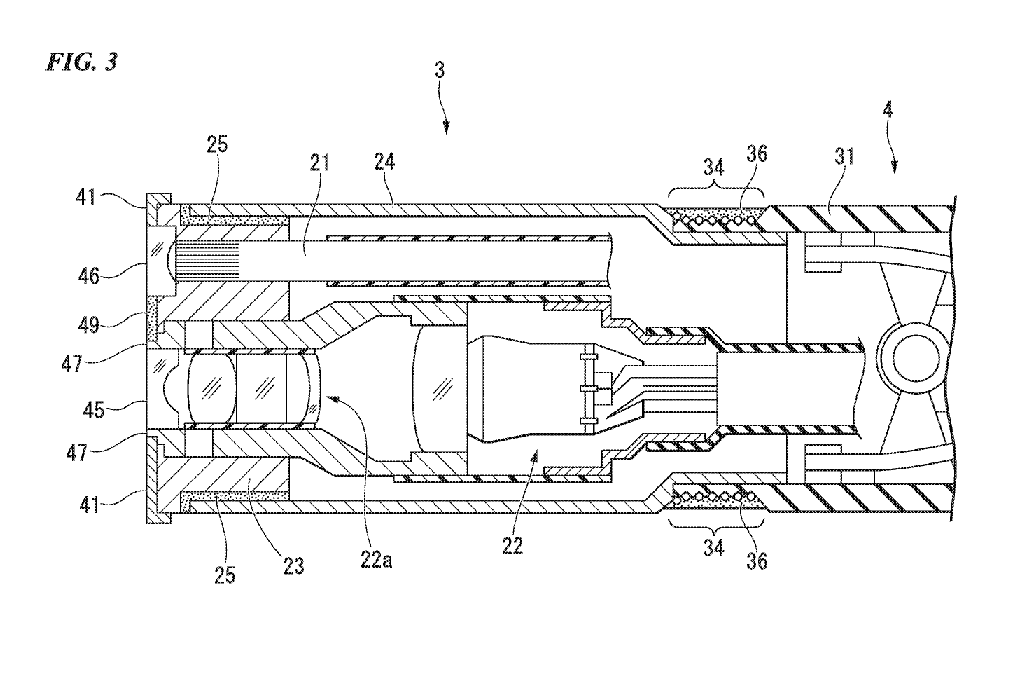

FIG. 1 is a perspective view illustrating an example of the schematic configuration of the endoscope of the present invention. FIG. 2 is a front view of a tip end portion of the endoscope in FIG. 1. FIG. 3 is a sectional view of the tip end portion taken along line A-A in FIG. 2.

The same reference signs will be assigned to the same configuration elements in FIG. 3 as those in FIG. 2, and a description thereof will be omitted.

As illustrated in FIG. 1, an endoscope 1 in an embodiment includes a slender insertion portion 2 inserted into the body of a subject; an operation portion 7 connected to the insertion portion 2; and a universal cord 8 which is electrically connected to the operation portion 7 and supplies illuminating light.

A tip end portion 3, a bending portion 4, and a flexible tube 5 are provided on a tip end side of the insertion portion 2. The tip end portion 3 illuminates illuminating light from a tip end, and receives reflected light from the inside of the body. The bending portion 4 and the flexible tube 5 are capable of accommodating an optical fiber through which light received by the tip end portion 3 is transmitted, and can be bent.

Members, which are joined together with the adhesive composition of the present invention in the endoscope 1, are not limited to specific members insofar as the members are configuration members of the endoscope 1.

The adhesive composition of the present invention can be applied to the vicinity of a lens frame in the tip end portion 3 of the endoscope 1.

FIG. 2 is a front view of the tip end portion 3 of the endoscope 1. A forceps channel 42 is provided in an insulating member 41, and a forceps sleeve 43 is disposed in an end portion of the forceps channel 42. An objective lens 45 is provided in an objective lens frame 47 while being disposed between two illumination lenses 46. A partitioning wall 48 is formed in the space between the illumination lens 46 and the objective lens 47, and is composed of an adhesive layer 49 formed by the adhesive composition of the present invention.

Accordingly, direct incidence of light from the illumination lens 46 to the objective lens 45 is prevented, and the illumination lens 46 and the objective lens frame 47 are fixed together with the adhesive layer 49.

As illustrated in FIG. 3, the tip end portion 3 of the endoscope 1 is provided with a light guide fiber 21 which supplies illuminating light, and a columnar block-shaped hard tip end portion 23 which holds an image capturing unit 22. A tip end cover 24 is fitted onto a side surface of the hard tip end portion 23. In the embodiment, an adhesive layer 25 formed by the adhesive composition of the present invention is provided in the fitting portion between the hard tip end portion 23 and the tip end cover 24, and is pasted to the hard tip end portion 23 and the tip end cover 24.

Cylindrical bent rubber 31 is inserted onto a proximal end side of the tip end cover 24, and covers the outer circumference of the bending portion 4. A thread bobbin portion 34 is formed by wrapping and tightly binding a thread around an inserting portion (inserted onto the proximal end) of the bent rubber 31 from the outside of the bent rubber 31. Therefore, the bent rubber 31 is fixed to the tip end cover 24.

An adhesive layer 36 is formed on the outer circumference of the thread bobbin portion 34 with the adhesive composition of the present invention, and outer surface finishing ensures the insertion of the insertion portion 2, and prevents the thread from being loose at the same time. That is, the thread bobbin portion 34 along side surfaces of the tip end cover 24 and the bent rubber 31 is coated with the adhesive layer 36. Accordingly, when the insertion portion 2 is inserted, the tip end portion 3 and the bending portion 4 can be smoothly slid against a living body while being in contact with the living body.

In the endoscope 1, it is possible to fix mouth portions of various tubes, which are inserted into the insertion portion 2 of the endoscope 1, to a tip end of the insertion portion 2 or the operation portion 7 with the adhesive composition of the present invention. A lens group 22a and the like, disposed in the hard tip end portion 23 of the insertion portion 2, may be fixed to the lens frame or the hard tip end portion 23 with the adhesive composition of the present invention.

A fiber bundle inserted into the insertion portion 2 may be fixed to the lens frame or the hard tip end portion 23 with the adhesive composition of the present invention. A CCD and the like of the image capturing unit 22 assembled into the tip end portion 3 can be protected, fixed, or sealed with the adhesive composition of the present invention.

The outer circumference of the connecting portion between the bending portion 4 and the flexible tube 5 has the same configuration as the outer circumference of the connecting portion between the tip end portion 3 and the bending portion 4, which is not illustrated. Specifically, a thread bobbin portion is formed in the connecting portion between the bending portion 4 and the flexible tube 5, and the adhesive composition of the present invention is applied to the outer circumference of the thread bobbin portion. The outer surface is finished by providing an adhesive layer using the adhesive composition, thereby ensuring the insertion of the insertion portion 2 and preventing the thread from becoming loose.

In the endoscope 1 in the embodiment, since members are joined together with the adhesive composition of the present invention, even if a sterilization treatment is repeatedly performed, the exterior of the adhesive layer is good, and the joined members are unlikely to be separated from each other.

### EXAMPLES

Hereinafter, the present invention will be described in more detail with reference to examples; however, the present invention is not limited to the examples.

Components used in the examples are illustrated below.

### Epoxy Resin (A)

Bisphenol A epoxy resin: product name “EPICLON (registered trademark) 840” manufactured by DIC Corporation

Bisphenol F epoxy resin: product name “EPICLON (registered trademark) 830” manufactured by DIC Corporation

Phenol novolak epoxy resin: product name “EPICLON (registered trademark) N-730A” manufactured by DIC Corporation

### Modified Silicone (B)

Epoxy-modified silicone: product name “SF8413” manufactured by Dow Corning Toray Co., Ltd.

Amine-modified silicone: product name “WACKER (registered trademark) FINISH WR301” manufactured by Wacker Asahikasei Silicone Co. Ltd.

### Comparative Component of Modified Silicone (B) (Hereinafter, Also Referred to as a “(B′) Component”)

Dimethyl silicone: product name “KF-96H” manufactured by Shin-Etsu Chemical Co., Ltd.

### Other Components

Metaxylylenediamine: curing agent, and product name “MXDA” manufactured by Mitsubishi Gas Chemical Company, INC.

Acrylic rubber: product name “Nipol (registered trademark) AR31” manufactured by Zeon Corporation

Silica: filler, and product name “silica microparticle” manufactured by Nippon Steel and Sumikin Materials Co. Ltd.

### <Manufacturing of Adhesive Composition>

Each adhesive composition is manufactured according to the corresponding composition (mixed components and the content (illustrated by % by mass) in an adhesive composition) of each mixed component illustrated in Tables 1 to 4 by the following corresponding manufacturing method. The content of a mixed component in the tables is expressed in terms of the pure content of the mixed component. In a case where a mixed component is blank in the tables, the mixed component is not mixed in the adhesive composition.

### Comparative Example 1

A main component was manufactured by mixing a bisphenol A epoxy resin and a phenol novolak epoxy resin together.

Subsequently, an adhesive composition was obtained by mixing the main component with metaxylylenediamine as a curing agent, acrylic rubber, and silica.

### Examples 1, 9, and 10

A main component was manufactured by mixing a bisphenol A epoxy resin, a phenol novolak epoxy resin, and epoxy-modified silicone together.

Subsequently, an adhesive composition was obtained by mixing the main component with metaxylylenediamine as a curing agent, acrylic rubber, and silica.

### Example 2

A main component was manufactured by mixing a bisphenol A epoxy resin and epoxy-modified silicone together.

Subsequently, an adhesive composition was obtained by mixing the main component with metaxylylenediamine as a curing agent, acrylic rubber, and silica.

### Example 3

A main component was manufactured by mixing a bisphenol A epoxy resin and a phenol novolak epoxy resin together.

Subsequently, an adhesive composition was obtained by mixing the main component with amine-modified silicone as a curing agent, acrylic rubber, and silica.

### Examples 4 to 8

A main component was manufactured by mixing a bisphenol A epoxy resin and a phenol novolak epoxy resin together.

Subsequently, an adhesive composition was obtained by mixing the main component with amine-modified silicone and metaxylylenediamine as a curing agent, acrylic rubber, and silica.

### Examples 11 to 20

An adhesive composition was obtained by the same method as in Examples 1 to except that a bisphenol A epoxy resin was changed to a bisphenol F epoxy resin.

### Examples 21, 29, and 30

A main component was manufactured by mixing a bisphenol A epoxy resin, a bisphenol F epoxy resin, a phenol novolak epoxy resin, and epoxy-modified silicone together.

Subsequently, an adhesive composition was obtained by mixing the main component with amine-modified silicone as a curing agent, acrylic rubber, and silica.

### Example 22

A main component was manufactured by mixing a bisphenol A epoxy resin, a bisphenol F epoxy resin, a phenol novolak epoxy resin, and epoxy-modified silicone together.

Subsequently, an adhesive composition was obtained by mixing the main component with amine-modified silicone as a curing agent and silica.

### Example 23

A main component was manufactured by mixing a bisphenol A epoxy resin and a bisphenol F epoxy resin together.

Subsequently, an adhesive composition was obtained by mixing the main component with amine-modified silicone and metaxylylenediamine as a curing agent, acrylic rubber, and silica.

### Examples 24 to 28

A main component was manufactured by mixing a bisphenol A epoxy resin, a bisphenol F epoxy resin, and epoxy-modified silicone together.

Subsequently, an adhesive composition was obtained by mixing the main component with amine-modified silicone and metaxylylenediamine as a curing agent, acrylic rubber, and silica.

### Comparative Examples 2, 10, and 11

A main component was manufactured by mixing a bisphenol A epoxy resin, a bisphenol F epoxy resin, and a phenol novolak epoxy resin together.

Subsequently, an adhesive composition was obtained by mixing the main component with dimethyl silicone, metaxylylenediamine as a curing agent, acrylic rubber, and silica.

### Comparative Example 3

A main component was manufactured by mixing a bisphenol A epoxy resin, a bisphenol F epoxy resin, and a phenol novolak epoxy resin together.

Subsequently, an adhesive composition was obtained by mixing the main component with dimethyl silicone, metaxylylenediamine as a curing agent, and silica.

### Comparative Examples 4 to 9

A main component was manufactured by mixing a bisphenol A epoxy resin and a bisphenol F epoxy resin together.

Subsequently, an adhesive composition was obtained by mixing the main component with dimethyl silicone, metaxylylenediamine as a curing agent, acrylic rubber, and silica.

### <Evaluation>

### [Evaluation for Sterilization Resistance]

### 1) Manufacturing of Test Specimen

A flat stainless steel (SUS) plate was used to manufacture a member imitating an insertion portion of a tip end of an endoscope.

Test specimens for evaluating the exterior were manufactured by respectively applying the adhesive compositions of the examples to the stainless steel (SUS) flat plates, and curing the stainless steel flat plates at 80° C. for two hours, and an adhesive layer (having a film thickness of 100 μm) was formed on each of the flat plates of the test specimens.

### 2) Evaluation for Sterilization Resistance

### 2-1) Autoclave Sterilization Test

In an autoclave sterilization test, the test specimens were sterilized with vapor at 135° C. in a vapor sterilization apparatus, then, the sterilized test specimens were removed to the atmosphere, and then the test specimens were sterilized with vapor at 135° C. in the vapor sterilization apparatus again.

After this sterilization treatment was repeatedly performed 100 times, an experimenter visually observed the adhesive layer on each of the test specimens for the occurrence of bubbles or cracking.

In a case where bubbles or cracking did not occur in the adhesive layers on the test specimens when the sterilization treatment was repeated 100 times in total, the sterilizing of these test specimens was additionally repeated. After the sterilization treatment was additionally repeated 100 times (200 times in total), the experimenter visually observed the adhesive layer on each of the test specimens for the occurrence of bubbles or cracking.

In a case where bubbles or cracking did not occur in the adhesive layers on the test specimens when the sterilization treatment was repeated 200 times in total, the sterilizing of these test specimens was additionally repeated. After the sterilization treatment was additionally repeated 50 times (250 times in total), the experimenter visually observed the adhesive layer on each of the test specimens for the occurrence of bubbles or cracking.

In a case where bubbles or cracking did not occur in the adhesive layers on the test specimens when the sterilization treatment was repeated 250 times in total, the sterilizing of these test specimens was additionally repeated. After the sterilization treatment was additionally repeated 50 times (300 times in total), the experimenter visually observed the adhesive layer on each of the test specimens for the occurrence of bubbles or cracking.

The results are illustrated in Tables 1 to 4.

### 2-2) Gaseous Sterilization Test

A sterilization method was changed from the autoclave sterilization test to a gaseous sterilization test. The gaseous sterilization test is a sterilization test in which the test specimens are sterilized in a low-temperature plasma sterilization apparatus using hydrogen peroxide gas. Other conditions were set to be the same as those described in 2-1). When the sterilization treatment was repeated 100 times in total, when the sterilization treatment was repeated 200 times in total, when the sterilization treatment was repeated 250 times in total, and when the sterilization treatment was repeated 300 times in total, the experimenter visually observed the adhesive layer on each of the test specimens for the occurrence of bubbles or cracking. The results are illustrated in Tables 1 to 4.

In the tables, in a case where the occurrence of bubbles or cracking was not observed in the adhesive layer even when the sterilization treatment was repeated 300 times in total, the test result was labeled as “excellent”. In a case where the occurrence of bubbles or cracking was not observed in the adhesive layer until the sterilization treatment was repeated 250 times in total, but the occurrence of bubbles or cracking was observed when the sterilization treatment was repeated 300 times in total, the test result was labeled as “good”. In a case where the occurrence of bubbles or cracking was not observed in the adhesive layer until the sterilization treatment was repeated 100 times in total, but the occurrence of bubbles or cracking was observed when the sterilization treatment was repeated 200 times in total, the test result was labeled as “fair”. In a case where the occurrence of bubbles or cracking was observed in the adhesive layer when the sterilization treatment was repeated 100 times in total, the test result was labeled as “poor”

TABLE 1

| | | | Comparative | | | | | |
|---|---|---|---|---|---|---|---|---|
| | | | Example 1 | Example 1 | Example 2 | Example 3 | Example 4 | Example 5 |
| (A) Component | bisphenol A | Main | 80 | 80 | 80 | 80 | 80 | 80 |
| | epoxy resin | Component | | | | | | |
| | bisphenol F | | | | | | | |
| | epoxy resin | | | | | | | |
| | phenol novolak | | 20 | 10 | | 20 | 20 | 20 |
| | epoxy resin | | | | | | | |
| (B) Component | epoxy-modified | | | 10 | 20 | | | |
| | silicone | | | | | | | |
| | amine-modified | Curing Agent | | | | 40 | 30 | 20 |
| | silicone | | | | | | | |
| Other | metaxylylenediamine | | 40 | 40 | 40 | | 10 | 20 |
| Components | | | | | | | | |

| | acrylic rubber | 20 | 20 | 20 | 20 | 20 | 20 |
|---|---|---|---|---|---|---|---|
| | silica | 20 | 20 | 20 | 20 | 20 | 20 |
| Content [parts by mass] ratio of (B) to 100 parts | | 0 | 11.1 | 25 | 40 | 30 | 20 |
| by mass of (A) | | | | | | | |
| Evaluation | Autoclave Sterilization | Fair | Excellent | Excellent | Excellent | Excellent | Excellent |
| | Resistance | | | | | | |
| | Gaseous Sterilization | Poor | Excellent | Excellent | Excellent | Excellent | Excellent |
| | Resistance | | | | | | |

| | | | | | | | Example |
|---|---|---|---|---|---|---|---|
| | | | Example 6 | Example 7 | Example 8 | Example 9 | 10 |
| (A) Component | bisphenol A | Main | 80 | 80 | 80 | 80 | 80 |
| | epoxy resin | Component | | | | | |
| | bisphenol F | | | | | | |
| | epoxy resin | | | | | | |
| | phenol novolak | | 20 | 20 | 20 | 15 | 5 |
| | epoxy resin | | | | | | |
| (B) Component | epoxy-modified | | | | | 5 | 15 |
| | silicone | | | | | | |
| | amine-modified | Curing Agent | 10 | 5 | 35 | | |
| | silicone | | | | | | |
| Other | metaxylylenediamine | | 30 | 35 | 5 | 40 | 40 |
| Components | | | | | | | |

| | acrylic rubber | 20 | 20 | 20 | 20 | 20 |
|---|---|---|---|---|---|---|
| | silica | 20 | 20 | 20 | 20 | 20 |
| Content [parts by mass] ratio of (B) to 100 parts | | 10 | 5 | 35 | 5.3 | 17.6 |
| by mass of (A) | | | | | | |
| Evaluation | Autoclave Sterilization | Excellent | Good | Excellent | Good | Excellent |
| | Resistance | | | | | |
| | Gaseous Sterilization | Excellent | Good | Excellent | Good | Excellent |
| | Resistance | | | | | |

TABLE 2

| | | | Example | Example | Example | Example | Example |
|---|---|---|---|---|---|---|---|
| | | | 11 | 12 | 13 | 14 | 15 |
| (A) Component | bisphenol A | Main | | | | | |
| | epoxy resin | Component | | | | | |
| | bisphenol F | | 80 | 80 | 80 | 80 | 80 |
| | epoxy resin | | | | | | |
| | phenol novolak | | 10 | | 20 | 20 | 20 |
| | epoxy resin | | | | | | |
| (B) Component | epoxy-modified | | 10 | 20 | | | |
| | silicone | | | | | | |
| | amine-modified | Curing Agent | | | 40 | 30 | 20 |
| | silicone | | | | | | |
| Other | metaxylylenediamine | | 40 | 40 | | 10 | 20 |
| Components | | | | | | | |
| | acrylic rubber | | 20 | 20 | 20 | 20 | 20 |
| | silica | | 20 | 20 | 20 | 20 | 20 |
| Content [parts by mass] ratio of (B) to 100 parts | | | 11.1 | 25 | 40 | 30 | 20 |
| by mass of (A) | | | | | | | |
| Evaluation | Autoclave Sterilization | | Excellent | Excellent | Excellent | Excellent | Excellent |
| | Resistance | | | | | | |
| | Gaseous Sterilization Resistance | | Excellent | Excellent | Excellent | Excellent | Excellent |
| | | | Example | Example | Example | Example | Example |
| | | | 16 | 17 | 18 | 19 | 20 |
| (A) Component | bisphenol A | Main | | | | | |
| | epoxy resin | Component | | | | | |
| | bisphenol F | | 80 | 80 | 80 | 80 | 80 |
| | epoxy resin | | | | | | |
| | phenol novolak | | 20 | 20 | 20 | 15 | 5 |
| | epoxy resin | | | | | | |
| (B) Component | epoxy-modified | | | | | 5 | 15 |
| | silicone | | | | | | |
| | amine-modified | Curing Agent | 10 | 5 | 35 | | |
| | silicone | | | | | | |
| Other | metaxylylenediamine | | 30 | 35 | 5 | 40 | 40 |
| Components | | | | | | | |

| | acrylic rubber | 20 | 20 | 20 | 20 | 20 |
|---|---|---|---|---|---|---|
| | silica | 20 | 20 | 20 | 20 | 20 |
| Content [parts by mass] ratio of (B) to 100 parts | | 10 | 5 | 35 | 5.3 | 17.6 |
| by mass of (A) | | | | | | |
| Evaluation | Autoclave Sterilization | Excellent | Good | Excellent | Good | Excellent |
| | Resistance | | | | | |
| | Gaseous Sterilization Resistance | Excellent | Good | Excellent | Good | Excellent |

TABLE 3

| | | | Example | Example | Example | Example | Example |
|---|---|---|---|---|---|---|---|
| | | | 21 | 22 | 23 | 24 | 25 |
| (A) Component | bisphenol A | Main | 40 | 40 | 40 | 40 | 40 |
| | epoxy resin | Component | | | | | |
| | bisphenol F | | 40 | 40 | 40 | 40 | 40 |
| | epoxy resin | | | | | | |
| | phenol novolak | | 10 | 20 | | | |
| | epoxy resin | | | | | | |
| (B) Component | epoxy-modified | | 40 | 40 | | 10 | 20 |
| | silicone | | | | | | |
| | amine-modified | Curing Agent | 20 | 20 | 20 | 20 | 20 |
| | silicone | | | | | | |
| Other | metaxylylenediamine | | | | 40 | 30 | 20 |
| Components | | | | | | | |
| | acrylic rubber | | 10 | | 20 | 20 | 20 |
| | silica | | 20 | 20 | 20 | 20 | 20 |
| Content [parts by mass] ratio of (B) to 100 parts | | | 66.7 | 60 | 25 | 37.5 | 50 |
| by mass of (A) | | | | | | | |
| Evaluation | Autoclave Sterilization | | Excellent | Excellent | Excellent | Excellent | Excellent |
| | Resistance | | | | | | |
| | Gaseous Sterilization Resistance | | Excellent | Excellent | Excellent | Excellent | Excellent |
| | | | Example | Example | Example | Example | Example |
| | | | 26 | 27 | 28 | 29 | 30 |
| (A) Component | bisphenol A | Main | 40 | 40 | 40 | 40 | 40 |
| | epoxy resin | Component | | | | | |
| | bisphenol F | | 40 | 40 | 40 | 40 | 40 |
| | epoxy resin | | | | | | |
| | phenol novolak | | | | | 5 | 15 |
| | epoxy resin | | | | | | |
| (B) Component | epoxy-modified | | 30 | 35 | 5 | 40 | 40 |
| | silicone | | | | | | |
| | amine-modified | Curing Agent | 20 | 20 | 20 | 20 | 20 |
| | silicone | | | | | | |
| Other | metaxylylenediamine | | 10 | 5 | 35 | | |
| Components | | | | | | | |

| | acrylic rubber | 20 | 20 | 20 | 15 | 5 |
|---|---|---|---|---|---|---|
| | silica | 20 | 20 | 20 | 20 | 20 |
| Content [parts by mass] ratio of (B) to 100 parts | | 62.5 | 68.8 | 31.3 | 70.6 | 63.2 |
| by mass of (A) | | | | | | |
| Evaluation | Autoclave Sterilization | Excellent | Excellent | Excellent | Excellent | Excellent |
| | Resistance | | | | | |
| | Gaseous Sterilization Resistance | Excellent | Excellent | Excellent | Excellent | Excellent |

TABLE 4

| | | | Comparative | Comparative | Comparative | Comparative | Comparative |
|---|---|---|---|---|---|---|---|
| | | | Example 2 | Example 3 | Example 4 | Example 5 | Example 6 |
| (A) Component | bisphenol A | Main | 40 | 40 | 40 | 40 | 40 |
| | epoxy resin | Component | | | | | |
| | bisphenol F | | 40 | 40 | 40 | 40 | 40 |
| | epoxy resin | | | | | | |
| | phenol novolak | | 10 | 20 | | | |
| | epoxy resin | | | | | | |
| (B) Component | dimethyl silicone | | 5 | 10 | 15 | 20 | 25 |
| Other | metaxylylenediamine | Curing Agent | 40 | 40 | 40 | 40 | 40 |
| Components | | | | | | | |
| | acrylic rubber | | 10 | | 20 | 20 | 20 |
| | silica | | 20 | 20 | 20 | 20 | 20 |
| Content [parts by mass] ratio of (B′) to 100 | | | 5.6 | 10 | 18.8 | 25 | 31.3 |
| parts by mass of (A) | | | | | | | |
| Evaluation | Autoclave Sterilization | | Fair | Fair | Fair | Fair | Fair |
| | Resistance | | | | | | |
| | Gaseous Sterilization | | Fair | Fair | Fair | Fair | Fair |
| | Resistance | | | | | | |
| | | | Comparative | Comparative | Comparative | Comparative | Comparative |
| | | | Example 7 | Example 8 | Example 9 | Example 10 | Example 11 |
| (A) Component | bisphenol A | Main | 40 | 40 | 40 | 40 | 40 |
| | epoxy resin | Component | | | | | |
| | bisphenol F | | 40 | 40 | 40 | 40 | 40 |
| | epoxy resin | | | | | | |
| | phenol novolak | | | | | 5 | 15 |
| | epoxy resin | | | | | | |
| (B) Component | dimethyl silicone | | 30 | 35 | 40 | 45 | 50 |
| Other | metaxylylenediamine | Curing Agent | 40 | 40 | 40 | 40 | 40 |
| Components | | | | | | | |

| | acrylic rubber | 20 | 20 | 20 | 15 | 5 |
|---|---|---|---|---|---|---|
| | silica | 20 | 20 | 20 | 20 | 20 |
| Content [parts by mass] ratio of (B′) to 100 | | 37.5 | 43.8 | 50 | 52.9 | 52.6 |
| parts by mass of (A) | | | | | | |
| Evaluation | Autoclave Sterilization | Fair | Fair | Fair | Fair | Fair |
| | Resistance | | | | | |
| | Gaseous Sterilization | Fair | Fair | Fair | Fair | Fair |
| | Resistance | | | | | |

It could be confirmed from the results in Tables 1 to 4 that the adhesive compositions in Examples 1 to 30 of the present invention had good sterilization resistance even if the adhesive compositions were repeatedly sterilized.

### [Measurement of Adhesive Strength]

The adhesive strength of the adhesive compositions in Examples 1 to 30 was measured in the following manner.

That is, test specimens were obtained by joining stainless steel flat plates to a target with the adhesive compositions of the examples, and curing the stainless steel flat plates at 80° C. for two hours. Subsequently, the test specimens were repeatedly sterilized 300 times in a low-temperature plasma sterilization apparatus using hydrogen peroxide gas.

Thereafter, the adhesive strength was measured by performing an adhesive strength test on the test specimens according to JIS K 6850 “test method for tensile shear adhesive strength of adhesive”.

As a result, the tensile shear strength of any one of the test specimens after the gaseous sterilization treatment was repeated 300 times was 10 MPa or greater.

### [Application of Present Invention to Endoscope]

Each of the adhesive compositions in Examples 1 to 6 was applied to multiple members in an endoscope having the same configuration as the endoscope in FIG. 1, and the multiple members were pasted together, and cured at 80° C. for two hours.

Specifically, a flexible outer tube end portion of an insertion portion, which is a member of the endoscope, was fixed to a member (tip end cover of a tip end portion) inside of the insertion portion by tightly binding the flexible outer tube end portion with a thread from the outside. Outer surface finishing was performed by applying the adhesive composition to the thread.

An image sensor of the endoscope was sealed with the adhesive composition.

In addition, angled portions in an outer circumference of an observation lens or an illumination lens of the endoscope were smoothed by forming a protruding adhesive layer in the vicinity of the observation lens or the illumination lens with the adhesive composition.

As described above, it was possible to join the members together in the endoscope without any problems.

The present invention is not limited to these examples, and can be modified in various forms and be realized insofar as the modifications do not depart from the purport of the present invention.

In the aforementioned description, an endoscope is exemplified as a medical device using the adhesive composition. The present invention is not limited to specific applications, and can be applied to medical devices which are used while being in contact with or inserted into a living body. For example, the adhesive composition of the present invention can be applied to medical devices such as various surgical devices, a cell extraction device, a blood cell separation device, and a blood transfusion device.

In the adhesive composition for medical devices, the medical device, and the endoscope in the embodiment, good sterilization resistance is obtained even if a sterilization treatment is repeatedly performed, the adhesive strength or the exterior of an adhesive layer can be maintained well, and joined members are unlikely to be separated from each other.

What is claimed is:

1. An adhesive composition for medical devices, comprising
at least one epoxy resin (A) selected from the group consisting of a bisphenol A epoxy resin, a bisphenol F epoxy resin, and a phenol novolak epoxy resin; and
modified silicone (B), wherein
the epoxy resin (A) is mixed with the modified silicone (1).

2. The adhesive composition for medical devices according to claim 1,
wherein the modified silicone (B) is at least one selected from the group consisting of epoxy-modified silicone and amine-modified silicone.

3. The adhesive composition for medical devices according to claim 2,
wherein the epoxy-modified silicone and the amine-modified silicone are used together as the modified silicone (B), and the mass ratio of the epoxy-modified silicone to the amine-modified silicone is in a range of 0.2 to 3.

4. The adhesive composition for medical devices according to claim 1,
wherein the mass average molecular weight of the modified silicone (B) is in a range of 100 to 10000.

5. The adhesive composition for medical devices according to claim 1,
wherein the content of the modified silicone (B) is in a range of 10 parts by mass to 75 parts by mass with respect to 100 parts by mass of the epoxy resin (A).

6. A medical device
wherein members are joined together with the adhesive composition for medical devices according to claim 1.

7. The medical device according to claim 6, comprising:
an insertion portion;
an operation portion connected to the insertion portion; and
a universal cord which is electrically connected to the operation portion.

8. A manufacturing method for an adhesive composition for medical devices, the method comprising:
a step of mixing at least one epoxy resin (A) selected from the group consisting of bisphenol A epoxy resin, bisphenol F epoxy resin, and phenol novolak epoxy resin with modified silicone (B).

9. The manufacturing method for an adhesive composition for medical devices according to claim 8,
wherein the modified silicone (B) is at least one selected from the group consisting of epoxy-modified silicone and amine-modified silicone.

10. The manufacturing method for an adhesive composition for medical devices according to claim 9,
wherein the epoxy-modified silicone and the amine-modified silicone are used together as the modified silicone (B), and the mass ratio of the epoxy-modified silicone to the amine-modified silicone is in a range of 0.2 to 3.

11. The manufacturing method for an adhesive composition for medical devices according to claim 8,
wherein the mass average molecular weight of the modified silicone (B) is in a range of 100 to 10000.

12. The manufacturing method for an adhesive composition for medical devices according to claim 8,
wherein the content of the modified silicone (B) is in a range of 10 parts by mass to 75 parts by mass with respect to 100 parts by mass of the epoxy resin (A).
